(19) United States
(12) Patent Application Publication
(10) Pub. No.: US 2004/0136149 A1
(43) Pub. Date: Jul. 15, 2004

(54) Portable computer having a hidden keyboard structure

(75) Inventors: Wen-Chieh Wang, Taipei (TW); Tsung-Kai Cheng, Taipei (TW); Tzu-Wei Lai, Taipei (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/622,696

(22) Filed: Jul. 21, 2003

(30) Foreign Application Priority Data
Jan. 13, 2003 (TW) 92200549

(51) Int. Cl. G06F 1/16

(52) U.S. Cl. 361/680

(57) ABSTRACT

A portable computer having a hidden keyboard structure is disclosed. The portable computer comprises: a shell having installed in the top face thereof a LCD panel and a keyboard, a protective cover pivoted to one peripheral side of the shell by a coupling mechanism and adaptable to cover the keyboard, the protective cover having a plurality of buttons mounted on the outer face and a cursor control device mounted on the inner face, and a flexible printed circuit connected between the shell and the protective cover for transmitting signals from the buttons and the cursor-control.

### BACKGROUND OF THE INVENTION

1. Field of the Invention

The present invention relates to a portable computer and, more particularly, to such a portable computer that has a hidden keyboard structure.

2. Description of Related Art

Portable computers have been gradually taking the place of desktop computers in the market. Portable computers include notebook, tablet PC, webpad, PDA, and etc. Tablet PC and webpad are new types of portable computers developed in recent years. These two new types are notebook-like mobile computers without keyboard, using a touch screen or touch pen for document data input. Normally, it is acceptable to input data by means of touch control or through a touch pen. However, when inputting a large amount of text data continuously using a tablet PC or webpad, a keyboard shall be preferred and connected to the tablet PC or webpad via a port (for example, PS/2 or USB port). It is inconvenient to carry and use an independent keyboard with a tablet PC or webpad.

### SUMMARY OF THE INVENTION

The invention has been accomplished under the circumstances in view. It is therefore the main object of the present invention to provide a hidden keyboard structure for a portable computer, which enables the user to use a keyboard for rapid data input.

It is another object of the present invention to provide a hidden keyboard structure for a portable computer, which protects the keyboard from accidentally touched when not in use.

To achieve these and other objects of the present invention, the portable computer having a hidden keyboard structure comprises a shell having a top face, a bottom face and four peripheral sides, said shell having installed in said top face thereof a LCD panel and a keyboard; a protecting cover pivoted to one of said peripheral sides adjacent to the keyboard of said shell by a coupling means thereof and adaptable to cover said keyboard, said protective cover having an outer face, an inner face opposite to said outer face, a plurality of buttons located on said outer face, and a cursor controlling device located on said inner face; and a cable means connected between said shell and said protecting cover for transmitting signals from said buttons and said cursor control.

### BRIEF DESCRIPTION OF THE DRAWINGS

FIG. 1 is a schematic drawing of the preferred embodiment of the present invention, showing the protective cover set in the close position.

FIG. 2 is another schematic drawing of the preferred embodiment of the present invention, showing the protective cover opened.

FIG. 3 is a schematic drawing of the preferred embodiment of the present invention, showing the protective cover rotated relative to the shell of the portable computer.

### DETAILED DESCRIPTION OF THE PREFERRED EMBODIMENT

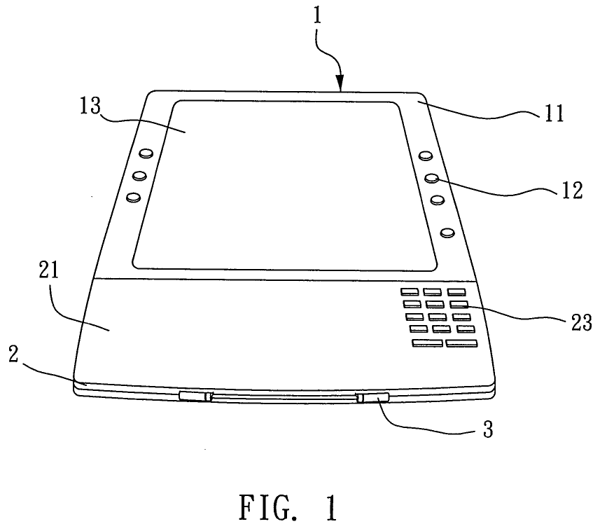

FIG. 1 is a schematic drawing showing a portable computer 1 having a hidden keyboard structure according to the present invention. Data can be inputted into the portable computer 1 via a touch pen or a touch control panel. The portable computer 1 comprises a shell 11 having a liquid crystal display screen 13 and a set of buttons 12 in the top face of it. A coupling mechanism 3 is provided in the bottom end of the top face of the shell 11 to hold a protective cover 2. The protective cover 2 has an outer face 21 and an inner face 22 (not shown). A set of buttons 23 is located on the outer surface 21 of the protective cover 2. The buttons 23 can be designed to function as the keys of a cellular phone for signal input such as, for example, to input digits.

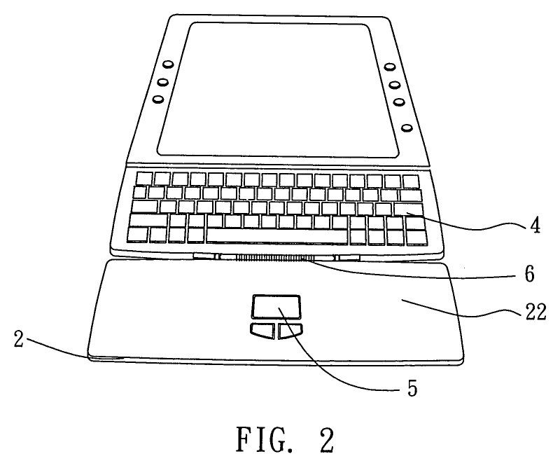

Referring to FIG. 2, the protective cover 2 is pivoted to the coupling mechanism 3, and can be rotated outwards to an open position. When the protective cover 2 rotates to the open position, a keyboard 4 is shown. At this time, the inner face 22 of the protective cover 2 faces upwards and a cursor control device 5 is located at the inner face 22 of the protective cover 2. According to the present preferred embodiment, the cursor control device 5 is a touchpad. Further, a flexible printed circuit 6 is connected between the protective cover 2 and the shell 11 for transmitting signals from the buttons 23 and the touchpad 5 to the internal circuit of the portable computer 1. When keyboard input is not necessary, the user can make a signal input through the buttons 23 or a touch control with the protective cover 2 covering the keyboard. When word processing is necessary, the user can open the protective cover 2 and use the touchpad 5 and the keyboard 4 for signal inputting. When operating the keyboard 4, the protective cover 2 can serve as a palm rest to support the palms. This orthopedically engineered design enables the user to operate the keyboard 4 comfortably with less effort.

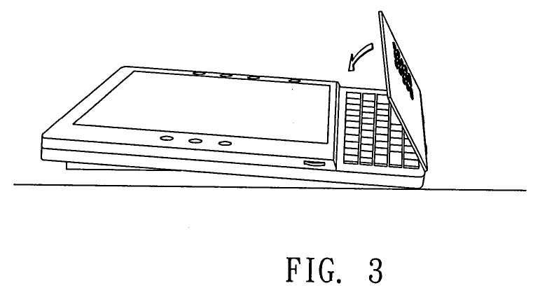

Referring to FIG. 3 and FIGS. 1 and 2 again, the protective cover 2 can be rotated outwards to the aforesaid open position as shown in FIG. 2, or inwards from the open position to the close position as shown in FIG. 1. When rotated to the close position as shown in FIG. 1, the keyboard 4 is kept from sight and well protected by the protective cover 2 to save space. Because the keyboard 4 is hidden inside the protective cover 2 when the protective cover 2 rotated to the close position, the user will not accidentally touch the keys of the keyboard 4.

In the aforesaid portable computer, the coupling mechanism between the shell and the protective cover may be variously embodied. Preferably, the coupling mechanism is a hinge structure. The cable connected between the shell and the protective cover can be of any of a variety of forms, preferably a flexible printed circuit. The cursor control device may be various embodied. For example, it can be a touchpad or trackpoint. The keyboard for the portable computer can be of any of a variety of commercially available designs, preferably, a standard 85-key keyboard. Further, the portable computer can be a touch-control portable computer, tablet PC, webpad, or PDA.

Although the present invention has been explained in relation to its preferred embodiments, it is to be understood that many other possible modifications and variations can be made without departing from the spirit and scope of the invention as hereinafter claimed.

What is claimed is:

1. A portable computer having a hidden keyboard structure, comprising:
a shell having a top face, and four peripheral sides, said shell having installed in said top face thereof a LCD panel and a keyboard;
a protecting cover pivoted to one of said peripheral sides adjacent to the keyboard of said shell by a coupling means thereof and adaptable to cover said keyboard, said protecting cover having an outer face, an inner face opposite to said outer face, a plurality of buttons located on said outer face, and a cursor controlling device located on said inner face; and
a cable means connected between said shell and said protecting cover for transmitting signals from said buttons and said cursor control.

2. The portable computer having a hidden keyboard structure as claimed in claim 1, wherein said cable means is comprised of a flexible printed circuit.

3. The portable computer having a hidden keyboard structure as claimed in claim 1, wherein said shell further comprises a plurality of buttons on the top face for signal input.

4. The portable computer having a hidden keyboard structure as claimed in claim 1, wherein said cursor controlling device is a touchpad.

5. The portable computer having a hidden keyboard structure as claimed in claim 1, wherein said cursor controlling device is a trackpoint.

6. The portable computer having a hidden keyboard structure as claimed in claim 1, wherein said keyboard is a standard 85-key keyboard.

7. The portable computer having a hidden keyboard structure as claimed in claim 1, wherein said portable computer is a tablet PC.
